(19) United States
(12) Patent Application Publication
(10) Pub. No.: US 2005/0281527 A1
(43) Pub. Date: Dec. 22, 2005

(54) Apparatus for optical cable management in a telecommunications network

(76) Inventors: David Wilson, Almonte (CA); Martin Bijman, Stittsville (CA); Dean Brinklow, Ottawa (CA); Colin Redknap, Almonte (CA)

Correspondence Address: MEREK, BLACKMON & VOORHEES, LLC, 673 S. WASHINGTON ST., ALEXANDRIA, VA, 22314, US

(21) Appl. No.: 11/149,147

(22) Filed: Jun. 10, 2005

(30) Foreign Application Priority Data
Jun. 16, 2004 (CA) 2,471,175

(51) Int. Cl. G02B 6/00

(52) U.S. Cl. 385/135

(57) ABSTRACT

An apparatus for managing optical cabling in a telecommunications storage unit. The storage unit includes an interior and an access opening. In its most preferred form the apparatus includes a rigid member having means for mounting in the telecommunications storage unit. The rigid member has a faceplate. The faceplate has a front face and a rear face. The front and rear faces face the access opening and interior of the telecommunications storage unit, respectively, when the rigid member is mounted therein. The faceplate has at least one opening formed therein for receiving through the front face at least one optical module. At least one cable management member is mounted on the front face of the faceplate for receiving optical cabling routed to the at least one optical module.

### FIELD OF THE INVENTION

The present invention relates generally to telecommunication networks and specifically to an apparatus and method for the organization of optical fiber cables in telecommunications storage units including but not limited to cabinets and racks with high levels of integration involving a diverse number of optical technologies.

### BACKGROUND OF THE INVENTION

In telecommunications systems, some equipment may be located in a remote location where cabinets or racks are used to house hardened electronics. These electronics are typically dedicated to deliver a particular type of service. Thus, the cabinet contains a multiplicity of circuit boards delivering a similar service that connect to wires or optical fibers. These wires or optical fibers go outside the cabinet further downstream to consumers' electronics at their premises. The cabinet also contains some common equipment for aggregating the data from the multiplicity of circuit boards and communicating upstream toward the service provider head end of the network.

For cabinets that deliver services on optical fibers, additional telecommunication storage units including cabinets, cross-connect boxes, pole or wall mounted boxes are located further downstream on the optical fibers towards customer premises. These additional telecommunication storage units house additional optical components including splitters and wavelength division multiplexer (WDM) blocks to combine the services from several different types of optical sources. In this regard, it is noted: (i) that optical services to numerous consumers are often shared on a single optical fiber; (ii) the fiber has such large information capacity; and (iii) that fewer fibers are sourced by service providers than in traditional copper or cable services. The use of a distributed model for optical cable management has evolved as new equipment is added to these networks from various vendors, and when new services are enabled by technological innovation and demanded by customers.

Traditional methods of cable management become particularly unsuitable as the optical equipment becomes smaller in size and lower in power, and as the regulatory rules allow equipment from various vendors to co-locate in one cabinet, and as the range of optical services demanded by individual customers becomes more varied, and as the optical fibers delivering these optical services to the customers are shared. The unsuitability of traditional methods of cable management in the aforementioned circumstances is due in part to the fact that traditional methods require numerous discrete cabinets, multiple cross-connect boxes, and splitters that are physically separated from each other and are thus expensive to access and maintain.

### OBJECTS AND SUMMARY OF THE INVENTION

It is an object of the present invention to obviate or mitigate at least some of the above-mentioned disadvantages of traditional methods and devices employed to manage cables.

In accordance with several aspects of the preferred embodiment of the present invention there is provided an optical fiber cable management unit located within a telecommunications storage unit. The telecommunications storage unit may house a diversity of optical service equipment providing service to customers from one or more different service providers, involving a diversity of physical optical fibers and connectors, that may span numerous optical wavelengths, where the optical fibers leaving the storage unit may be shared among many customers. The optical fiber cable management unit includes one or more slots that house one or more optical cable management modules. The optical fiber cable management unit further includes a cable management member that serves to route cables while accommodating the cables' limitation regarding minimum bend radius. The cable management member also serves to manage optical fiber cable slack and heat droop management. The optical fiber cable management unit formed in accordance with the preferred embodiment of the present invention includes at least the following advantages: (i) allows storage unit integration in short periods of time; (ii) offers the flexibility of using different types of cable management modules that insert in slots on the faceplate of the optical fiber cable management unit; (iii) enables effective optical fiber management of the optical fibers within the storage unit; and, (iv) permits the configuration of the optical components in the storage unit to be readily changed as new equipment and customer services are delivered from the service equipment in the storage unit.

### BRIEF DESCRIPTION OF THE DRAWINGS

FIG. 1 is a block diagram illustrating a distribution network for optical fiber cables in accordance with the prior art;

FIG. 2 is a block diagram illustrating a typical cabinet for housing a diversity of optical equipment and optical connection banks, splitters, and WDM optical blocks;

FIG. 3 is a front perspective view illustrating an apparatus for the management of optical fibers cables formed in accordance with a preferred embodiment of the invention; and,

FIG. 4 contains side and front views illustrating a circular rigid protrusion for the apparatus formed in accordance with a preferred embodiment of the invention.

### DETAILED DESCRIPTION OF THE PREFERRED EMBODIMENTS

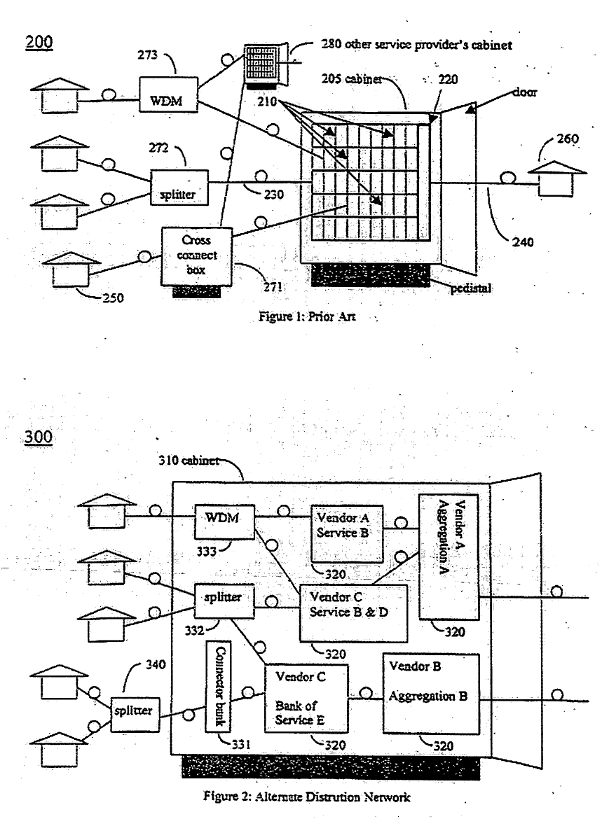

For convenience, like numerals in the description refer to like structure in the drawings. The preferred forms of the invention will be described with reference to FIGS. 2-4. The appended claims are not limited to the preferred forms and no term and/or phrase used herein is to be given a meaning other than its ordinary meaning unless it is expressly stated that the term and/or phrase shall have a special meaning. The environment of an existing, i.e., prior art, optical fiber cable network 200 will be described with reference to FIG. 1.

Referring to FIG. 1, optical fiber cable network includes a cabinet 205 housing a multiplicity of similar circuit boards 210 delivering a similar service. The circuit boards 210 connect to wires or optical fibers 230 that extend outside the cabinet further downstream to consumers' electronics at their premises 250. The circuit boards 210 are also connected to some common equipment 220. Equipment 220 aggregates the data from the multiplicity of circuit boards 210 and communicates upstream on shared optical fiber 240 toward the service provider head end 260 of the network. The network also includes external third party cabinets 280, cross-connect boxes 271, splitters 272, and WDM blocks 273. The aforementioned components of the network cooperate to allow the network 200 to connect a multiplicity of service providers with a multiplicity of customers where the services are carried on a network of optical fiber cables and optical combining equipment.

Referring to FIG. 2, an alternative distribution network 300 is illustrated. Cabinet 310, unlike cabinet 205, houses a plurality of optical network components formerly organized in a physically distributed fashion. The optical network components disposed in cabinet 310 may include: (i) equipment 320 from several different vendors as allowed by regulatory bodies, safety, heat, and space restrictions; (ii) equipment that delivers diverse services as defined by technology innovation, standards, and customer service demand; and, (iii) optical coupling equipment, for example connector banks 331 to provide connectivity of individual optical fiber cables leaving the cabinet to optical fiber cables connected to various pieces of optical equipment within the cabinet, splitters 332 for dividing an optical fiber to provide the light information to several customers, and WDM blocks 333 for combining multiple spectrum of light on a single fiber as allowed by the optical equipment and subscriber services demands. Splitters 340, as well as other optical network components, may continue to reside outside the cabinet 310. Splitter 340, as is common practice, allows a single fiber to serve a multiplicity of customers.

When integrating cabinet 310, the optical equipment is typically rack mounted, but may be mounted in any other suitable fashion. Due to the numerous additional components in cabinet 310, space inside the cabinet 310 is at a premium. For example, connector banks 331, splitters 332, and WDM blocks 333 are often shoehorned in where they can fit, and the cables routed and strapped down. This method of managing components of the network is inefficient, slow to integrate, slow to rework, prone to mechanical damage, and potentially damaging to the optical fibers, which would lead to low reliability.

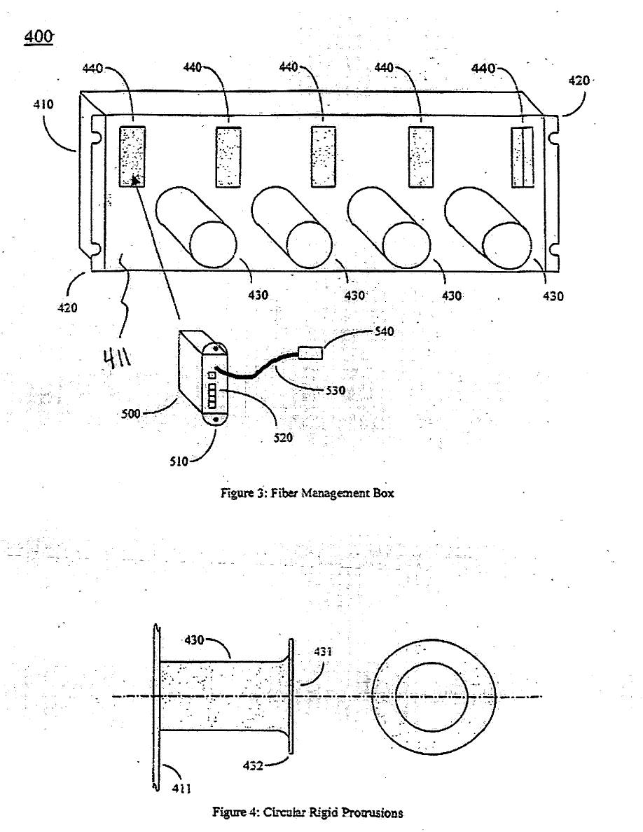

Thus, according to the most preferred form of the present invention, there is provided an optical cable management unit 400 as illustrated in FIG. 3. Optical cable management unit 400 combines multiple optical fiber technologies for delivery of services to multiple customers with diverse service needs.

In the most preferred form, the optical cable management unit 400 includes a rigid box 410 having protrusions 420. Protrusions 420 facilitate rack mounting as a shelf. The unit 400 may also be mounted using any other suitable means. It will be readily appreciated that the unit 400 need not have a back of any kind. In addition, the unit 400 may take the form of a panel having means for rack mounting among many other forms.

According to one aspect of the preferred form of the present invention, the faceplate 411 of the rigid box 410 has formed therein a plurality of openings 440 generally spaced evenly and regularly across the faceplate 411. Openings 440 are adapted to receive a variety of optical modules 500 which provide optical connectivity from the front panel of the optical modules 500 and hence the front of unit 400.

According to another aspect of the preferred form of the present invention, the rigid box 410 includes a number of generally circular rigid protrusions 430 extending outwardly from the front of faceplate 411. Preferably, protrusions 430 are generally spaced evenly between the openings 440 and in a vertical line slightly offset from a vertical line passing through openings 440. Preferably, protrusions 430 have a diameter sufficiently large to allow the fiber with the lowest allowable bending radius to be routed around the circular protrusions 430 and connected into connectors on the faceplates of the optical modules 500. Bending radius as used herein refers to a bending radius that will allow the fiber to function as intended.

Further, as illustrated in FIG. 4, relative to the faceplate 411 of the optical fiber cable management box 410, the circular rigid protrusions 430 have a lip 432 at the open end 431 of the cylinder 430. For example, the protrusions 430 may be hollow metal cylinders, 1 inch in radius and 3 inches in length, and with a quarter inch lip 432 at the open end 431 of the cylinder 430. By providing a set of such cylinders 430 and their relative spacing and distance to the optical modules 500, the cable slack can be managed to reduce damage and improve reliability, and to accommodate heat droop of the optical fiber cables due to heating that may occur in the environment in which the equipment resides. The lip 432 on the open end 431 of the circular rigid protrusions 430 prevents fibers from slipping or otherwise falling off of the protrusions 430 during installation and throughout the life cycle of the unit 400. Thus, the invention provides an apparatus that allows service personnel to complete the quick, tidy and safe routing of optical fibers from various directions throughout the cabinet 310, to allow the integration of the cabinet 310 and management of the optical fiber cables extending between a diversity of optical fiber equipment.

According to another aspect of the most preferred form of the present invention, the optical modules 500 may include a mounting means 510 for mounting the optical modules 500 to the faceplate 411 of the rigid box 410. The mounting means 510 may take many forms including but not limited to holes formed in protrusions extending outwardly from the optical module 500. The module 500 can be removably detached to the faceplate 411 with screws inserted into the openings formed in the optical module and corresponding openings formed in faceplate 411. It will be readily appreciated that any other mounting means may be employed including but not limited: (i) clips or latches, which may be quick-connect and disconnect in nature; (ii) tracks around the edges of the holes 440 extending backward behind the faceplate 411 of the rigid box 410 along which the optical modules 500 would be guided into position; or, (iii) other mechanical means to provide quick mounting and un-mounting of the optical modules 500.

According to another aspect of the most preferred form of the present invention, the optical modules 500 may consist of a pair or sets of pairs of connector pairs 520 for the connection of two optical fiber cables, one of which may leave the cabinet, and one or both of which may connect to optical equipment in the cabinet 310. In this way, the invention provides connector functionality.

According to another aspect of the most preferred form of the present invention, the optical modules 500 may consist of a set of connectors 520 for the optical connection of multiple fibers to a single fiber at the same wavelength with the use of an optical splitter located behind the faceplate of the optical module 500. In this way, the invention provides splitter functionality.

According to another aspect of the most preferred form of the present invention, the optical modules 500 may consist of a variety of connectors 520 for the optical connection of single or multiple fibers to a single fiber, where different connectors are required for the first single or multiple fibers and for the second single fiber. In this way, the invention provides adapter functionality.

According to another aspect of the most preferred form of the present invention, the optical modules 500 may consist of a variety of connectors 520 for the optical connection of multiple fibers to a harness 530 of optical fibers that extends out of the faceplate of the optical module 500 and includes a particular length of optical fiber cable and a specific connector or connectors 540 as are appropriate for the particular optical connectivity desired. In this way, the invention provides cabling to connector functionality.

According to another aspect of the most preferred form of the present invention, the optical modules 500 may consist of a set of connectors 520 for the optical connection of multiple fibers to a single fiber where the multiple fibers operate at different wavelengths and are mixed using a WDM block that resides behind the faceplate of the optical module 500. In this way, the invention provides WDM functionality.

According to another aspect of the most preferred form of the present invention, the functionality of individual optical modules can be combined to provide new functionality, such as combining the splitter module functionality with the adapter module functionality in one module, or combining the WDM functionality with the cabling out of the front panel of the module functionality in one module.

According to another aspect of the most preferred form of the present invention, the optical modules 500 may be easily removed and replaced with other optical modules 500 that perform a different function or for replacement of a module due to failure or maintenance, to enable ease of improvement, refinement, alteration, and upgrade of the equipment and the optical fiber cables connected to that equipment within the cabinet 310.

According to another aspect of the invention, the optical fiber cable management unit 400 may be utilized in applications other than remote cabinets 310, such as central offices, and rack mounted equipment, for example.

According to another aspect of the most preferred form of the present invention, the optical modules 500 may include passive components, active components, or a combination of passive and active components.

Advantageously, the unit 400 allows for the insertion and removal of modules 500 and cables 230 from the front of a cabinet 310 or other storage device in which it is installed. Access to the rear of the unit 400 is not generally required. This allows for rapid development and maintenance of fiber optic equipment installed in the unit 400 and cabinet 310 or other storage device.

While this invention has been described as having a preferred design, it is understood that the preferred design can be further modified or adapted following in general the principles of the invention and including but not limited to such departures from the present invention as come within the known or customary practice in the art to which the invention pertains. The claims are not limited to the preferred embodiment and have been written to preclude such a narrow construction using the principles of claim differentiation.

1. An apparatus for managing optical cabling connected to a telecommunications storage unit, said apparatus comprising:
an optical cabling management element adapted to be operably connected to the telecommunications storage unit, said optical cabling management element having a front face and a rear face, said front face of said optical cabling management element being readily accessible when said optical cabling management element is connected to the telecommunications storage unit;
said front face of said optical cabling management element having a plurality of openings formed therein, said openings being sized and shaped to receive at least one optical module; and,
at least one cable management member for receiving optical cabling routed to the at least one optical module, said at least one cable management member extending outwardly from said front face of said optical cable management element.

2. The apparatus of claim 1, wherein:
each cable management member has a cylindrical member, a longitudinal axis of which is generally perpendicular to said front face.

3. The apparatus of claim 2, wherein:
said cylindrical member is hollow.

4. The apparatus of claim 2, wherein:
said cylindrical member has an annular lip formed at an end distal from said front face for restraining optical cabling mounted on said cylindrical member.

5. The apparatus of claim 1, wherein:
said optical cable management element is a panel.

6. The apparatus of claim 1, wherein:
said optical cable management element is a box.

7. The apparatus of claim 1, wherein:
the at least one optical module includes at least one of a passive component and an active component.

8. A system for managing optical cabling in a telecommunications network; said system comprising:
a telecommunications storage unit storing at least one optical coupling component;
an optical cabling management element operably connected to said telecommunications storage unit, said optical cabling management element having a front face and a rear face,
said front face of said optical cabling management element having a plurality of openings formed therein, said openings each receiving at least one optical module;
said front face of said optical cabling management element being oriented relative to said telecommunications storage unit such that said at least one optical module is accessible without disconnecting said optical cable management element from said telecommunications storage unit; and,
at least one cable management member for receiving optical cabling routed to the at least one optical module, said at least one cable management member extending outwardly from said front face of said optical cable management element.

9. A system as set forth in claim 8, further including:
at least one optical cable connected to said at least one optical module, at least a portion of said optical cable being wrapped around said at least one cable management member.

10. A system as set forth in claim 9, wherein:
said at least one cable management member has a sufficient size to accommodate the bend radius of all optical cables operably associated with said telecommunications storage unit.

11. A system as set forth in claim 10, wherein:
said at least one optical module is connected to an optical coupling component disposed behind said optical cable management element.

12. A system as set forth in claim 11, wherein:
said optical coupling component disposed behind said optical cable management element is a splitter.

13. A system as set forth in claim 11, wherein:
said optical coupling component disposed behind said optical cable management element is a wavelength division multiplexer.

14. A system as set forth in claim 8, wherein:
said telecommunications storage unit is a cabinet.

15. A system as set forth in claim 8, wherein:
said telecommunications storage unit is a rack.

16. A system as set forth in claim 8, further including:
first, second and third openings formed in said front face of said optical cable management element; and,
first and second cable management members connected to and extending outwardly from said front face of said optical cable management element, said first and second cable management members being offset in vertical and horizontal directions from said first, second and third openings.

17. A method of managing optical cabling in a telecommunications network, said method comprising the steps of:
providing a telecommunications storage unit with at least one optical coupling component;
providing an optical cabling management element having a front face and a rear face, the front face of the optical cabling management element having a plurality of openings formed therein;
connecting the optical cabling management member to the telecommunications storage unit such that the front face of the optical cable management element is readily accessible when the telecommunications storage unit is accessed;
inserting at least one optical module in at least one of the plurality of openings in the front face of the optical cable managing element; and,
providing at least one cable management member extending outwardly from the front face of the optical cable management element.

18. A method as recited in claim 17, including the further steps of:
connecting at least one optical cable to at least one of the optical modules; and,
wrapping at least a portion of said at least one optical cable around said cable management member.

19. A method as recited in claim 18, including the further step of:
providing the cable management member with a retaining member for retaining the corresponding portion of the optical cable on the cable management member.

20. A method as recited in claim 17, wherein:
the telecommunications storage unit is a cabinet having an access door.
